(19) United States
(12) Patent Application Publication
(10) Pub. No.: US 2020/0379417 A1
(43) Pub. Date: Dec. 3, 2020

(54) TECHNIQUES FOR USING MACHINE LEARNING FOR CONTROL AND PREDICTIVE MAINTENANCE OF BUILDINGS

(71) Applicants: Baosen Zhang, Seattle, WA (US); Yize Chen, Seattle, WA (US); Yuanyuan Shi, Seattle, WA (US); Sarang Amirtabar, Renton, WA (US); He Hao, Bothell, WA (US)

(72) Inventors: Baosen Zhang, Seattle, WA (US); Yize Chen, Seattle, WA (US); Yuanyuan Shi, Seattle, WA (US); Sarang Amirtabar, Renton, WA (US); He Hao, Bothell, WA (US)

(73) Assignees: University of Washington, Seattle, WA (US); Centrica Business Solutions US, Inc., Houston, TX (US)

(21) Appl. No.: 16/425,657

(22) Filed: May 29, 2019

(51) Int. Cl. G05B 13/02; G05B 13/04; G06N 3/08; G06N 5/04; G06N 20/00; F24F 11/63

(52) U.S. Cl. CPC G05B 13/027; G05B 13/04; F24F 11/63; G06N 5/046; G06N 20/00; G06N 3/08

(57) ABSTRACT

In some embodiments, input convex neural networks are used to model and control complex physical systems. In some embodiments, input convex recurrent neural networks are used to capture temporal behavior of dynamical systems. Optimal controllers may be achieved via solving a convex model predictive control problem. Such models and controllers are useful in controlling many types of complex physical systems, including but not limited to heating, ventilation, and air conditioning (HVAC) systems in order to greatly reduce energy consumption compared to classic linear models and controllers.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a system for controlling environmental conditions within a building is provided. The system comprises a heating, ventilation, and air conditioning (HVAC) system, one or more environmental sensors, an intelligent management device. The intelligent management device includes at least one processor, at least one network interface that communicatively couples the intelligent management device to the one or more environmental sensors and the HVAC system, and a non-transitory computer-readable medium. The computer-readable medium has computer-executable instructions stored thereon that, in response to execution by the at least one processor, cause the intelligent management device to perform actions comprising: receiving, from the one or more environmental sensors, environmental data that represents an environment associated with the building; using an input convex neural network model to determine one or more control inputs for the HVAC system based on the environmental data; and transmitting the one or more control inputs to the HVAC system.

In some embodiments, a method of controlling environmental conditions within a building is provided. A computing device receives environmental data generated by one or more environmental sensors that represents an environment associated with the building. The computing device provides the environmental data as input to an input convex neural network model. The computing device determines one or more control inputs for a heating, ventilation, and air conditioning (HVAC) system based on one or more outputs of the input convex neural network model. The one or more control inputs are transmitted to the HVAC system.

In some embodiments, a non-transitory computer-readable medium having computer-executable instructions stored thereon is provided. The instructions, in response to execution by one or more processors of a computing device, cause the computing device to perform actions for training a machine learning model to control environmental conditions within a building. The actions comprise determining, by the computing device, a set of fixed control inputs for a heating, ventilation, and air conditioning (HVAC) system; transmitting, by the computing device, the set of fixed control inputs to the HVAC system; receiving, by the computing device, environmental data generated by one or more environmental sensors that represents an environment associated with the building as affected by the HVAC system while operated using the set of fixed control inputs; storing, by the computing device, the set of fixed control inputs and the environmental data in a training data store; training, by the computing device, an input convex neural network model using information stored in the training data store; and storing, by the computing device, the trained input convex neural network model in a model data store.

In some embodiments, a method of training a machine learning model to control a physical system is provided. A computing device determines a set of fixed control inputs for the physical system. The computing device transmits the set of fixed control inputs to the physical system. The computing device receives result data collected while they physical system is operated using the set of fixed control inputs. The computing device stores the set of fixed control inputs and the result data in a training data store. The computing device trains an input convex neural network model using information stored in the training data store. The computing device stores the trained input convex neural network model in a model data store.

In some embodiments, a method of controlling a physical system using a machine learning model is provided. Data that represents an environment associated with the physical system is received from one or more sensors. An input convex neural network model is used to determine one or more control inputs for the physical system based on the data. The one or more control inputs are transmitted to the physical system.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram that illustrates a non-limiting example embodiment of a system for controlling an environment of a building according to various aspects of the present disclosure;

FIG. 2 is a block diagram that illustrates details of a non-limiting example embodiment of an intelligent management device, environment sensor devices, and an HVAC system according to various aspects of the present disclosure;

FIG. 3A is a schematic diagram that illustrates a non-limiting example embodiment of an input convex feed-forward neural network (ICNN) according to various aspects of the present disclosure;

FIG. 3B is a schematic diagram that illustrates a non-limiting example embodiment of an input convex recurrent neural network (ICRNN) according to various aspects of the present disclosure;

FIG. 4 is a flowchart that illustrates a non-limiting example embodiment of a method of training an input convex neural network model to represent response of a building to HVAC controls according to various aspects of the present disclosure;

FIGS. 5A-5B are a flowchart that illustrates a non-limiting example embodiment of a method of controlling an HVAC system using a convex neural network model according to various aspects of the present disclosure;

FIGS. 6A-6D illustrate various experimental results of using embodiments of the present disclosure to reduce energy consumption of an HVAC system; and

FIG. 7 is a block diagram that illustrates aspects of an exemplary computing device appropriate for use as a computing device of the present disclosure.

### DETAILED DESCRIPTION

Decisions on how to best operate and control complex physical systems such as the power grid, commercial and industrial buildings, transportation networks and robotic systems are of critical societal importance. Since buildings account for 40% of the global energy consumption, many approaches have been proposed to operate buildings more efficiently by controlling their heating, ventilation, and air conditioning (HVAC) systems. These systems are often challenging to control because they tend to have complicated and poorly understood dynamics, sometimes with legacy components, and are built over a long period of time. Therefore, detailed models for these systems may not be available or may be intractable to construct. Most of these methods, however, suffer from two drawbacks. First, while a detailed physics model of a building could be used to accurately describe its behavior, this model can take years to develop. Second, while simple control algorithms have been developed by using linear (RC circuit) models to represent buildings, the performance of these models is generally poor since the building dynamics can be far from linear. What is desired are techniques that can strike a balance between requiring painstaking manual construction of physics-based models and the risk of not capturing rich and complex system dynamics through models that are too simplistic.

In recent years—with the growing deployment of sensors in physical and robotics systems—large amount of operational data have been collected, such as in smart buildings, legged robotics, and manipulators. Using these data, the system dynamics can be learned directly and then automatically updated at periodic intervals. One popular method is to parameterize these complex system dynamics using deep neural networks to capturing complex relationships, yet few researchers investigated how to integrate deep learning models into real-time closed-loop control of physical systems.

A key reason that deep neural networks have not been directly applied in control is that even though they provide good performances in learning system behaviors, optimization on top of these networks is challenging. Neural networks, because of their structures, are generally not convex from input to output. Therefore, many control applications (e.g., where real-time decisions need to be made) choose to favor the computational tractability offered by linear models despite their poor fitting performances.

In the present disclosure, we tackle the modeling accuracy and control tractability tradeoff by using input convex neural networks (ICNN) to both represent system dynamics and to find optimal control policies. By making the neural network convex from input to output, we are able to obtain both good predictive accuracies and tractable computational optimization problems.

Some embodiments of the present disclosure firstly utilize an input convex network model to learn the system dynamics and then compute the best control decisions via solving a convex model predictive control (MPC) problem, which is tractable and has optimality guarantees. This is different from existing methods that use model-free end-to-end controller which directly maps input to output. ICNN has been found to be capable of representing all convex functions and systems dynamics, and is exponentially more efficient than widely used convex piecewise linear approximations.

Control and decision-making have used deep learning mainly in model-free end-to-end controller settings, such as sequential decision making in game, robotics manipulation, and control of cyber-physical systems. Much of the success in such techniques relies heavily on a reinforcement learning setup where the optimal state-action relationship can be learned via a large number of samples. However, many physical systems do not fit into the reinforcement learning process, where both the sample collection is limited by real-time operations, and there are physical model constraints hard to represent efficiently.

To address the above sample efficiency, safety, and model constraints incompatibility concerns faced by model-free reinforcement learning algorithms in physical system control, we consider a model-based control approach. Model-based control algorithms often involve two stages—system identification and controller design. For the system identification stage, the goal is to learn a fixed form of system model to minimize some prediction error. Most efficient model-based control algorithms have used a relatively simple function estimator for the system dynamics identification, such as linear model and Gaussian processes. These simplified models are sample-efficient to learn, and can be nicely incorporated in the sub-sequent optimal control problems. However, such simple models may not have enough representation capacity in modeling large-scale or high-dimension systems with nonlinear dynamics. Deep neural networks (DNNs) feature powerful representation capability, but the main challenge of using DNNs for system identification is that such models are typically highly non-linear and non-convex, which causes great difficulty for following decision making. The proposed ICNN control algorithm achieves the benefits from both sides of the world.

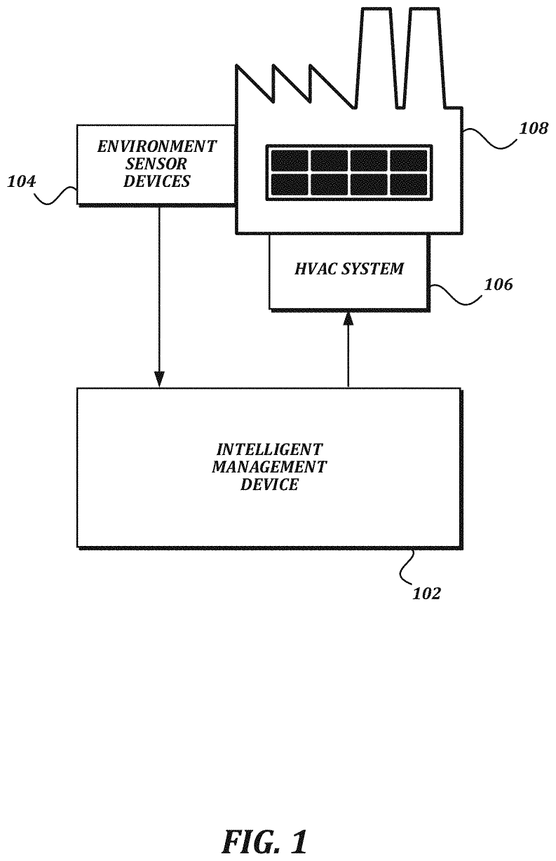

FIG. 1 is a schematic diagram that illustrates a non-limiting example embodiment of a system for controlling an environment of a building according to various aspects of the present disclosure. As is typical, an environment of a building 108 is managed by an HVAC system 106. The building 108 may be any type of building that includes an HVAC system 106, including but not limited to a commercial building, an office building, a warehouse, a residence, a retailer, or any other type of building that uses an HVAC system 106 to control an environment of the building 108. The building 108 may include one or more environment sensor devices 104. As discussed in further detail below, the environment sensor devices 104 detect aspects of the environment of the building 108, and/or aspects of an ambient environment surrounding the building 108. The environment sensor devices 104 then provide information regarding the detected aspects of the environment to an intelligent management device 102. The intelligent management device 102 may train one or more machine learning models based on the information received from the environment sensor devices 104, and may use those machine learning models to generate control signals for the HVAC system 106. Further information regarding each of these aspects of the system is provided below.

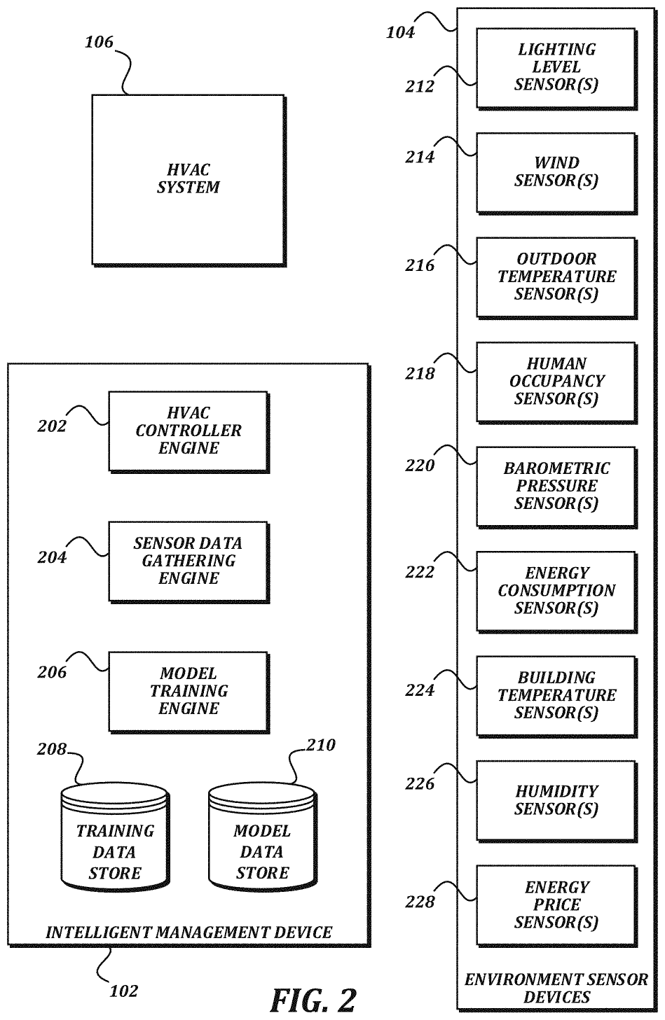

FIG. 2 is a block diagram that illustrates details of a non-limiting example embodiment of an intelligent management device, environment sensor devices, and an HVAC system 106 according to various aspects of the present disclosure. The HVAC system 106, the intelligent management device 102, and the environment sensor devices 104 may be communicatively coupled to each other via any suitable technique, including but not limited to using one or more wireless communication technologies including but not limited to Wi-Fi, Bluetooth, ZigBee, 2G, 3G, 4G, 5G, and LTE; and/or one or more wired communication technologies including but not limited to Ethernet, USB, FireWire, serial cabling, power-line networking, BACnet, optical fiber, and X-10. The intelligent management device 102 may be any type of computing device capable of performing the actions described herein as being performed by the intelligent management device 102. In some embodiments, the intelligent management device 102 may be a desktop computing device, a laptop computing device, a rack-mount computing device, or another form factor computing device present on-premises at the building 108. In some embodiments, the intelligent management device 102 may be a computing device of any form factor that communicates with the HVAC system 106 and the environment sensor devices 104 via a network such as the internet. In some embodiments, the intelligent management device 102 may be a virtual device hosted in a cloud computing system. In some embodiments, the functionality of the intelligent management device 102 may be collectively provided by two or more computing devices. In some embodiments, the functionality of the intelligent management device 102 may be incorporated into the HVAC system 106 or a controller that is co-located with the HVAC system 106.

In the illustrated embodiment, the intelligent management device 102 includes an HVAC controller engine 202, a sensor data gathering engine 204, a model training engine 206, a training data store 208, and a model data store 210. In some embodiments, the sensor data gathering engine 204 is configured to receive signals from the environment sensor devices 104. The sensor data gathering engine 204 may then store information associated with the signals in the training data store 208 for use in training one or more machine learning models, and/or may provide information associated with the signals to the HVAC controller engine 202. In some embodiments, the HVAC controller engine 202 is configured to receive the information associated with the signals from the sensor data gathering engine 204, to use the information as input to a machine learning model stored in the model data store 210 in order to generate control inputs for the HVAC system 106, and to transmit the control inputs to the HVAC system 106. In some embodiments, the HVAC controller engine 202 may also be configurable to operate the HVAC system 106 according to a predetermined schedule in order to generate training data. The model training engine 206 is configured to use the information stored in the training data store 208 to generate one or more machine learning models that characterize the behavior of the building 108 in response to various control inputs for the HVAC system 106, and to store the machine learning models in the model data store 210. The model training engine 206 may also be configured to update the stored machine learning models once additional training data is gathered.

In general, the term “engine” as used herein refers to logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, application-specific languages such as Matlab, and/or the like. An engine may be compiled into executable programs or written in interpreted programming languages. Engines may be callable from other engines or from themselves. Generally, the engines described herein refer to logical modules that can be merged with other engines or applications, or can be divided into sub-engines. The engines can be stored in any type of computer readable medium or computer storage device and be stored on and executed by one or more general purpose computers, thus creating a special purpose computer configured to provide the engine. Accordingly, the devices and systems illustrated herein include one or more computing devices configured to provide the illustrated engines.

In general, a “data store” as described herein may be provided by any suitable device configured to store data for access by a computing device. One example of a data store is a highly reliable, high-speed relational database management system (RDBMS) executing on one or more computing devices and accessible locally or over a high-speed network. However, any other suitable storage technique and/or device capable of quickly and reliably providing the stored data in response to queries may be used, such as a key-value store, an object database, and/or the like. The computing device providing the data store may be accessible locally instead of over a network, or may be provided as a cloud-based service. A data store may also include data stored in an organized manner on a computer-readable storage medium, as described further below. Another example of a data store is a file system or database management system that stores data in files (or records) on a computer readable medium such as flash memory, random access memory (RAM), hard disk drives, and/or the like. Separate data stores described herein may be combined into a single data store, and/or a single data store described herein may be separated into multiple data stores, without departing from the scope of the present disclosure.

The environment sensor devices 104 are various devices configured to detect conditions in, around, or relating to the building 108. The environment sensor devices 104 are configured to detect conditions, and then to transmit signals that include information relating to the conditions to the intelligent management device 102. In some embodiments, the environment sensor devices 104 transmit signals continuously or periodically, and provide the information in a time series. In some embodiments, the intelligent management device 102 is configured to request information from the environment sensor devices 104, and the environment sensor devices 104 are configured to provide the signals containing the information in response to the requests. In some embodiments, the building 108 may be segmented into multiple zones, and separate environment sensor devices 104 may be provided in each zone in order to provide different HVAC setpoints for different zones within the building 108. In the illustrated embodiment, the environment sensor devices 104 include a variety of devices. Some of the devices detect conditions inside the building 108. These devices may include one or more lighting level sensors 212 (which detect a level of light inside the building 108 in order to determine whether additional lighting should be activated), one or more human occupancy sensors 218 (which detect whether a human is present near the sensor in order to determine whether lights should be activated, a different temperature setpoint should be used, or for other reasons), one or more building temperature sensors 224 (which detect a temperature at a point inside the building 108), and one or more humidity sensors 226 (which detect a humidity at a point inside the building 108).

Some of the environment sensor devices 104 detect conditions outside of the building 108 that may affect the performance of the HVAC system 106 or the dynamics of the building 108. These devices may include one or more wind sensors 214 (which detect a wind speed and/or direction outside the building 108), one or more outdoor temperature sensors 216 (which detect an ambient temperature), and one or more barometric pressure sensors 220 (which monitor barometric pressure).

Some of the environment sensor devices 104 detect other conditions relating to the building 108 that may not affect the dynamics of the building 108 with regard to the HVAC system 106, but may affect the performance or may be usable to assess the performance of the HVAC system 106. These devices may include one or more energy consumption sensors 222 (which detect how much energy is consumed by the HVAC system 106 and/or the building 108 as a whole), and one or more energy price sensors 228 (which detect a cost of energy being consumed by the HVAC system 106 and/or the building 108 as a whole, which may change depending on a time of day or an overall power demand).

Further details of the actions performed by the components of the intelligent management device 102, the environment sensor devices 104, and the HVAC system 106 are provided below.

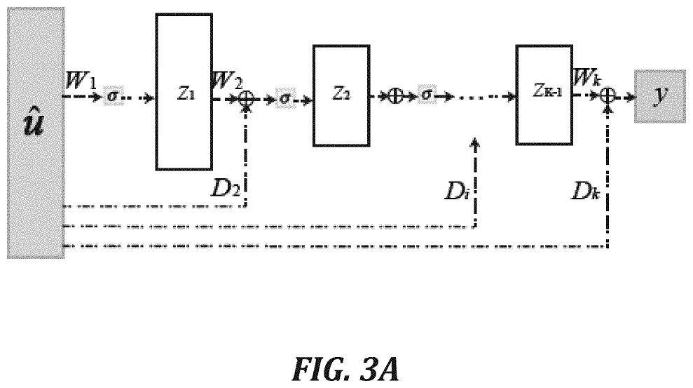

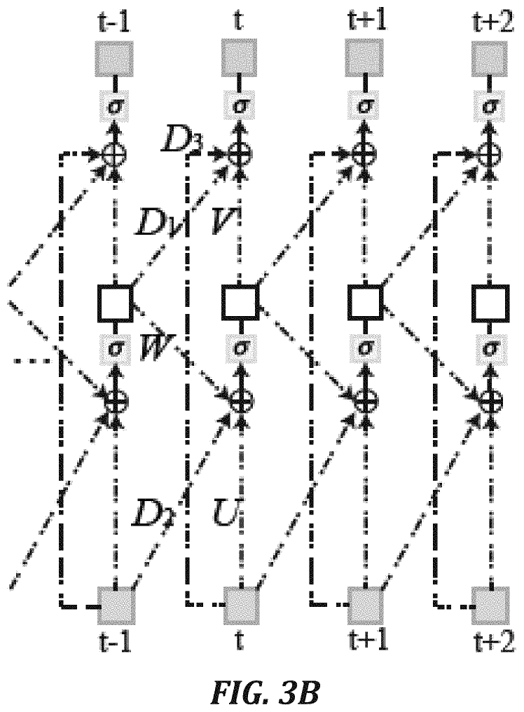

FIG. 3A is a schematic diagram that illustrates a non-limiting example embodiment of an input convex feed-forward neural network (ICNN) according to various aspects of the present disclosure. This schematic diagram illustrates one non-limiting example of a structure of a model that may be trained by the model training engine 206, stored in the model data store 210, and used by the HVAC controller engine 202.

The input û includes the inputs u as well as their negations −u, such that:

$$\hat{u} = [ \begin{matrix}u \\ - u\end{matrix} ]$$

The ICNN includes hidden layers z₁. . . zₖ₋₁, as well as direct passthrough layers D_{2:k} that connect the inputs to the hidden units for better model representation ability. The weights of each element are represented by W, and the activations are represented by σ. The illustrated neural network is convex from input to output given that all weights between layers W_{1:k} and weights in the passthrough layers D_{2:k} are nonnegative, and all of the activation functions are convex and nondecreasing. One non-limiting example of a convex and nondecreasing activation function is a rectified linear unit (ReLU) function. This construction achieves the exact representation of dynamical systems by expanding the inputs to include both u (∈ [symbol] ^{d}) and −u. Then, any negative weights in W₁ and D_{2:k} are set to zero, and its negation (which is positive) is added as the weight for corresponding −u. This allows the network to be “rolled out in time” when dealing with dynamical systems and multiple networks need to be composed together.

A simple example that demonstrates how the proposed ICNN can be used to fit a convex function comes from fitting the |u| function. This function is convex and both decreasing and increasing. Let the activation function be:

ReLU(.)=max(.,0)

We can write:

|u|=−u+2ReLU(u)

However, this representation uses a negative weight (the −1 in front of u), and this would be troublesome if several networks were composed together. Hence, in the proposed ICNN structure that uses all positive weights and input negation duplicates, we can instead write:

|u|=v+2ReLU(u)

where we impose a constraint v=−u. Such doubling of the number of input variables could potentially make the network harder to train, yet during control, having all of the weights positive maintains the convexity between inputs and outputs even if multiple steps are considered. The constraint v=−u is linear and can be easily included in any convex optimization.

Compared to conventional feed-forward neural networks, the present disclosure adds (1) the direct “passthrough” layers connecting inputs to hidden layers and conventional “feed-forward” layers connecting hidden layers for better representation power, and (2) the expanded inputs that include both u and −u. Such construction guarantees that the network is convex and non-decreasing with respect to the expanded inputs, while the output can achieve either decreasing or non-decreasing functions over u.

Fundamentally, the use of an ICNN allows neural networks to be used in decision making processes by guaranteeing the solution is unique and globally optimal. Since many complex input and output relationships can be learned through deep neural networks, it is natural to consider using the learned network in an optimization problem in the form of:

$${min}_{u} f ( u \text{;} W )$$

$$s . t . u ∈ 𝒰$$

where [symbol] is a convex feasible space. Then, if f is an ICNN, optimizing over u is a convex problem, which can be solved efficiently to global optimality. Note that duplicating the variables by introducing v=−u does not change the convexity of the problem. The performance of the network (e.g., classification) may be worse by restricting the weights to non-negative values, but trading off classification performance for tractability can be preferable.

While the feed-forward ICNN illustrated in FIG. 3A is useful for single-shot optimization problems, optimal control of a dynamical system such as a building environment may include temporal dependency. To model the temporal dependency of the system dynamics of such a system, recurrent neural networks may be used instead of feed-forward neural networks. Recurrent networks carry an internal state of the system, which introduces coupling with previous inputs to the system.

FIG. 3B is a schematic diagram that illustrates a non-limiting example embodiment of an input convex recurrent neural network (ICRNN) according to various aspects of the present disclosure. This schematic diagram illustrates one non-limiting example of a structure of a model that may be trained by the model training engine 206, stored in the model data store 210, and used by the HVAC controller engine 202.

The inputs, which are the same as the model illustrated in FIG. 3A, are illustrated in the blocks at the bottom of FIG. 3B, while the outputs are illustrated in the blocks at the top of FIG. 3B. Again, the weights are non-negative, and the inputs are expanded with their negations. The network illustrated in FIG. 3B maps from input a to output y with memory unit z according to the following:

$${z}_{t} = {σ}_{1} ( U {\hat{u}}_{t} + {Wz}_{t - 1} + {D}_{2} {\hat{u}}_{t - 1} ) , \\ {y}_{t} = {σ}_{2} ( {Vz}_{t} + {D}_{1} {z}_{t - 1} + {D}_{3} {\hat{u}}_{t} ) , \\ where$$

$$\hat{u} = [ \begin{matrix}u \\ - u\end{matrix} ]$$

and D₁, D₂, D₃ are added direct passthrough layers for augmenting representation power. If the dynamics are unrolled with respect to time, one has:

yₜ=f(û₁,û₂, . . . , ûₜ;θ)

where θ=[U, V, W, D₁, D₂, D₃] are network parameters, and σ₁, σ₂ denote the nonlinear activation functions. This network is a convex function from inputs to output when all of the weights U, V, W, D₁, D₂, D₃ are non-negative, and all activation functions are convex and non-decreasing (such as ReLU). The proof of this proposition follows directly from the composition rule of convex functions. Similarly to the ICNN case, by expanding the inputs vector to include both u and −u, and restricting all weights to be non-negative, the resulting ICRNN structure is a convex and non-decreasing mapping from inputs to output.

The proposed ICRNN structure can be leveraged to represent system dynamics for closed-loop control. Consider a physical system with discrete-time dynamics, at time step t, sₜ is defined as the system states, uₜ as the control actions, and yₜ as the system output. For example, for the real-time control of a building system, sₜ may include such non-limiting example factors as temperature, humidity, lighting levels, particulate levels, air change rates, etc; uₜ may include such non-limiting example factors as the building appliance scheduling, room temperature set-points, etc; and output yₜ may represent the building energy consumption. In addition, there may be exogenous variables that impact the output of the system. For example, outside temperature, humidity, sun intensity, etc., will impact the energy consumption of the building. However, since the exogenous variables are not impacted by any of the control actions, they may be suppressed in the formulation below.

The time evolution of a system is described by:

yₜ=f(sₜ,uₜ),

sₜ₊₁=g(sₜ,uₜ)

where the second equation describes the coupling between the current inputs to the future system states. Physical systems described by these equations may have significant inertia in the sense that the outcome of any control action may be delayed in time, and there are significant couplings across time periods.

Since ICRNNs are used to represent both the system dynamics g(.) and the output f(.), the control variable u expands as û. The optimal receding horizon control problem at time t can be written as:

$$\begin{matrix}{minimize}_{{u}_{t} , {u}_{t + 1} , … , {u}_{t + T}} C ( \hat{x} , y ) = {\sum }_{τ = t}^{t + T} J ( {\hat{x}}_{τ} , {y}_{τ} ) & ( 1 a ) \\ subject to {y}_{τ} = f ( {\hat{x}}_{τ - {n}_{w}} , {\hat{x}}_{τ - {n}_{w + 1}} , … , {\hat{x}}_{τ} ) , ∀ τ ∈ [ t , t + T ] & ( 1 b ) \\ {s}_{τ} = g ( {\hat{x}}_{τ - {n}_{w}} , {\hat{x}}_{τ - {n}_{w + 1}} , … , {\hat{x}}_{τ - 1} , {\hat{u}}_{τ} ) , ∀ τ ∈ [ t , t + T ] & ( 1 c ) \\ {\hat{x}}_{τ} = [ \begin{matrix}{s}_{τ} \\ {\hat{u}}_{τ}\end{matrix} ] , {\hat{u}}_{τ} = [ \begin{matrix}{u}_{τ} \\ {v}_{τ}\end{matrix} ] , ∀ τ ∈ [ t , t + T ] & ( 1 d ) \\ {v}_{τ} = - {u}_{τ} , ∀ τ ∈ [ t , t + T ] & ( 1 e ) \\ {s}_{τ} ∈ {𝒮}_{feasible} , ∀ τ ∈ [ t , t + T ] & ( 1 f ) \\ {u}_{τ} ∈ {𝒰}_{feasible} , ∀ τ ∈ [ t , t + T ] & ( 1 g )\end{matrix}$$

where a new variable \hat{x}=[sₜ, ûₜ] is introduced for notational simplicity, which may be called system inputs. This is the collection of system states sₜ and duplicated control actions uₜ and −uₜ, therefore ensuring the mapping from uₜ to any future states and outputs remains convex. The expression J(\hat{x}_{τ}y_{τ}) is the control system cost incurred at time τ, that is a function of both the system inputs \hat{x}_{τ} and output y_{τ}. The functions f(.) and g(.) in equations (1b)-(1c) are parameterized as ICRNNs, which represent the system dynamics from a sequence of inputs \hat{x}_{τ-n}_{_{w}},\hat{x}_{τ-n}_{_{w+1}}, . . . , \hat{x}_{τ} to the system output y_{τ}, and the dynamics from control actions to system states, respectively. n_{w} is the memory window length of the recurrent neural network. The equations (1d) and (1e) duplicate the input variables u and enforce the consistency condition between u and its negation v. Lastly, equations (1f) and (1g) are the constraints on feasible system states and control actions, respectively. Note that as a general formulation, the duplication techniques are not included on state variables, so the dynamics fitted by equations (1b) and (1c) are non-decreasing over state space, which are not equivalent to those dynamics represented by linear systems. However, since the control space is not restricted, and multiple previous states are explicitly included in the system transition dynamics, the non-decreasing constraint over state space should not unduly restrict the representation capacity.

The optimization problem of the equations (1a)-(1g) is a convex optimization with respect to inputs uₜ, uₜ₊₁, . . . , u_{t+T}, provided the cost function J(\hat{x}_{τ},y_{τ})=J(s_{τ},û_{τ},y_{τ}) is convex with respect to û_{τ}, and convex and non-decreasing with respect to s_{τ} and y_{τ}. A problem is convex if both the objective function and constraints are convex. In the above problem, since f and g are parameterized as ICRNNs, they are convex and non-decreasing functions from input to output. Therefore, it is straightforward to show that both the objective function (1a) and constraints (1b)-(1c) are convex following the composition rule of convex functions.

The convexity of the above problem guarantees that it can be solved efficiently and optimally using the gradient descent method. Since both the objective function (1a) and the constraints (1b)-(1c) are parameterized as neural networks, their gradients can be calculated via back-propagation with the modification where cost is propagated to the input rather than the weights of the network. For implementation, the gradients can be conveniently calculated using existing modules such as Tensorflow via back-propagation.

Let:

u*={u*ₜu*ₜ₊₁, . . . , u*_{t+T}}

be the optimal solution of the optimization problem at time t. Then the first element of u* is implemented to the real-time system control, that is u*ₜ. The optimization problem is repeated at time t+1, based on the updated state prediction using u*ₜ, yielding a model predictive control strategy.

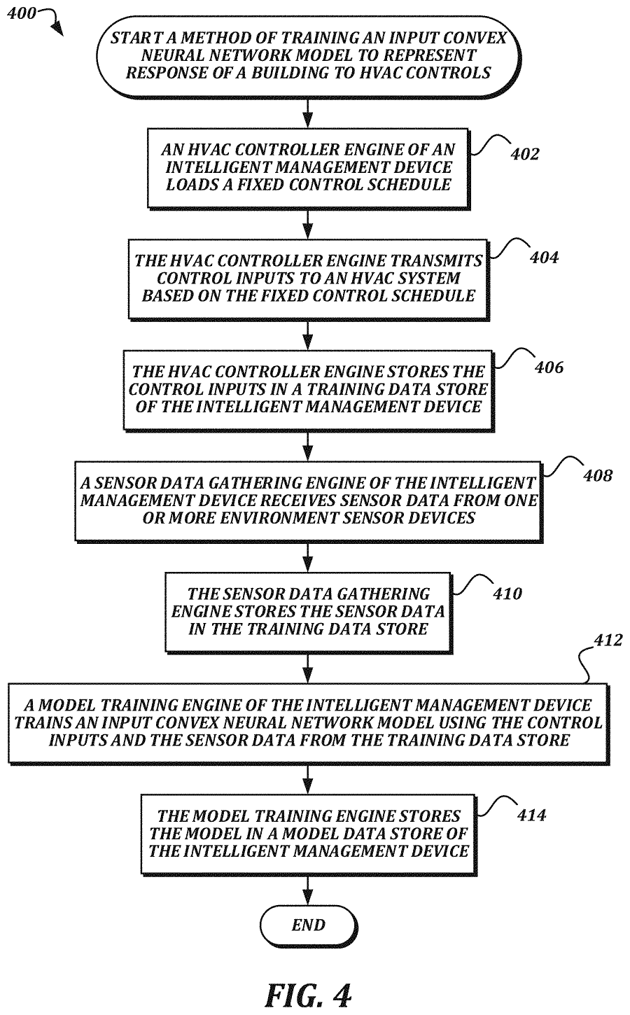

FIG. 4 is a flowchart that illustrates a non-limiting example embodiment of a method of training an input convex neural network model to represent response of a building to HVAC controls according to various aspects of the present disclosure. At a high level, the model represents the response of the building 108 when various control inputs are applied to the HVAC system 106 given various data collected from environment sensor devices 104, and can be used to determine appropriate control inputs to keep the environment of the building 108 within a setpoint range.

From a start block, the method 400 proceeds to block 402, where an HVAC controller engine 202 of an intelligent management device 102 loads a fixed control schedule. The fixed control schedule may be stored in the model data store 210, stored in the training data store 208, or coded directly into the HVAC controller engine 202. In some embodiments, the fixed control schedule includes a time series of set points or control inputs usable to control the HVAC system 106.

At block 404, the HVAC controller engine 202 transmits control inputs to an HVAC system 106 based on the fixed control schedule. In embodiments wherein the fixed control schedule specifies the control inputs themselves, the control inputs may simply be sent to the HVAC system 106. In embodiments wherein the fixed control schedule indicates a set point, the HVAC controller engine 106 may determine control inputs based on the set point and information received from the environment sensor devices 104 using a basic control scheme, such as a PID controller, a PI controller, a linear model, or any other control scheme. The determined control inputs may then be transmitted to the HVAC system 106.

At block 406, the HVAC controller engine 202 stores the control inputs in a training data store 208 of the intelligent management device 102. In some embodiments, the control inputs may be stored in records that also store a time at which the control inputs were transmitted to the HVAC system 106. At block 408, a sensor data gathering engine 204 of the intelligent management device 102 receives sensor data from one or more environment sensor devices 104, and at block 410, the sensor data gathering engine 204 stores the sensor data in the training data store 208. In some embodiments, the sensor data is stored in records that store a time at which the sensor data was collected and/or a time which the sensor data represents, thus allowing the sensor data to be associated in time with the stored control inputs.

At block 412, a model training engine 206 of the intelligent management device trains an input convex neural network model using the control inputs and the sensor data from the training data store 208. In some embodiments, the input convex neural network model may be an ICNN as illustrated in FIG. 3A and described above. In some embodiments, the input convex neural network model may be an ICRNN as illustrated in FIG. 3B and described above. Any suitable technique for training the model using the control inputs and the sensor data as training data may be used, including but not limited to gradient descent. Because the model is guaranteed to be convex, finding a globally optimal solution is a tractable problem.

Returning to FIG. 4, at block 414, the model training engine 206 stores the model in a model data store 210 of the intelligent management device 102. In some embodiments, the model stored in the model data store 210 includes weights to be applied in the neural network. In some embodiments, the model stored in the model data store 210 may include a number of nodes to include in each hidden layer of the neural network, and/or a number of hidden layers to use in the neural network, which may be determined as part of the hyperparameter tuning process. The method 400 then proceeds to an end block and terminates.

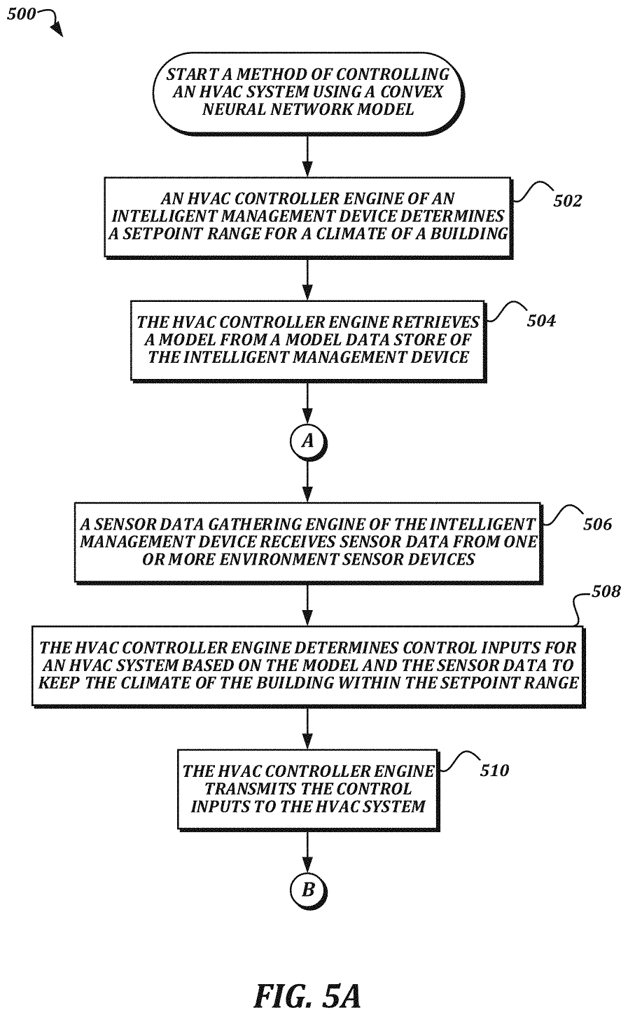

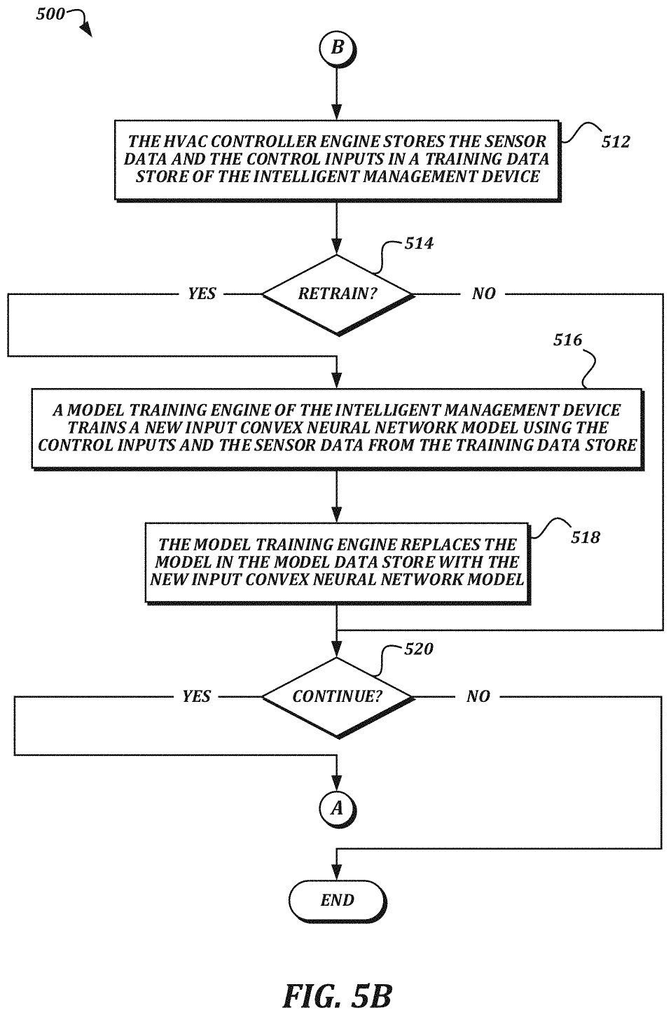

FIGS. 5A-5B are a flowchart that illustrates a non-limiting example embodiment of a method of controlling an HVAC system using a convex neural network model according to various aspects of the present disclosure. From a start block, the method 500 proceeds to block 502, where an HVAC controller engine 202 of an intelligent management device 102 determines a setpoint range for a climate of a building 108. The setpoint range may be determined by a manager of the building 108 based on preferences of the tenants of the building 108. For example, the setpoint range may specify that the building 108 should be kept between 68 degrees Fahrenheit and 74 degrees Fahrenheit. In some embodiments, the setpoint range may be determined by being entered into a user interface of the intelligent management device 102. In some embodiments, the setpoint range may include multiple setpoint ranges based on time. For example, in the winter when heating will predominate, a setpoint range for an office building may be higher (e.g., 68-72 degrees Fahrenheit) during the day when the building is likely to be occupied than during the night when the building 108 is unlikely to be occupied (e.g., 64-68 degrees Fahrenheit), in order to save energy while the building 108 is unlikely to be occupied.

At block 504, the HVAC controller engine 202 retrieves a model from a model data store 210 of the intelligent management device 102. It is assumed in the method 500 that a model of the building 108 has been trained via a method such as the method 400 illustrated and described above, and has been stored in the model data store 210 for retrieval at block 504. In some embodiments, the model may have been generated and stored by a different computing device than the computing device that provides the HVAC controller engine 202.

The method 500 proceeds through a continuation terminal (“terminal A”) to block 506, where a sensor data gathering engine 204 of the intelligent management device 102 receives sensor data from one or more environment sensor devices 104. As stated above, the sensor data may include information about the environment inside the building 108, surrounding the building 108, or relating to the building 108, and may be provided in a time series. The sensor data may include timestamps for individual data points within the respective time series.

At block 508, the HVAC controller engine 202 determines control inputs for an HVAC system 106 based on the model and the sensor data to keep the climate of the building 108 within the setpoint range. As discussed above, the time series sensor data may be used as the inputs u to the model, and the outputs y may represent the quantity to be controlled (e.g., the overall power consumption). In some embodiments, the control inputs may themselves be provided as set point ranges for operation of various components within the HVAC system 106. At block 510, the HVAC controller engine 202 transmits the control inputs to the HVAC system 106.

The method 500 then proceeds to a continuation terminal (“terminal B”). From terminal B (FIG. 5B), the method 500 proceeds to block 512, where the HVAC controller engine 202 stores the sensor data and the control inputs in a training data store 208 of the intelligent management device 102. The HVAC controller engine 202 may also continue to receive sensor data from the one or more environment sensor devices 104 in a time series, and may store the sensor data time series along with currently active control inputs in the training data store 208 for use as additional training data. As sensor data is collected, the HVAC controller engine 202 may continue to determine new control inputs using the model, and may continue to transmit the new control inputs to the HVAC system 106.

At decision block 514, a determination is made regarding whether the model should be retrained. In some embodiments, the model may be retrained periodically, such as once a day, once a week, once an hour, or on any other appropriate schedule. In some embodiments, the model may be retrained upon receiving a command to retrain the model from a user. In some embodiments, the model may be retrained upon automatically determining that the control inputs are changing in larger than expected amounts, thereby indicating that the model is no longer accurately representing the dynamics of the building 108. In some embodiments, the model may be retrained upon determining that a predetermined amount of new training data has been stored in the training data store 208.

If it is determined that the model should be retrained, then the result of decision block 514 is YES, and the method 500 proceeds to block 516, where a model training engine 206 of the intelligent management device 102 trains a new input convex neural network model using the control inputs and the sensor data from the training data store 208. In some embodiments, the new training data that has been stored in the training data store 208 may be used as at least part of the training data set. At block 518, the model training engine 206 replaces the model in the model data store 210 with the new input convex neural network model. The method 500 then proceeds to decision block 520. Returning to block 514, if it is determined that the model should not be retrained, then the result of decision block 514 is NO, and the method 500 proceeds directly from decision block 514 to decision block 520.

At decision block 520, a determination is made regarding whether the control of the HVAC system 106 using the model should continue. In some embodiments, the control of the HVAC system 106 using the model continues indefinitely, unless specifically interrupted by an operator. In some embodiments, the control of the HVAC system 106 may be automatically interrupted if it is determined that the model is not able to keep the building 108 within the setpoint range, and an alert may be transmitted to a manager to indicate that the controller is not working properly. If it is determined that the intelligent management device 102 should continue to control the HVAC system 106 using the model, then the result of decision block 520 is YES, and the method 500 returns to terminal A. Otherwise, if it is determined that the intelligent management device 102 should stop controlling the HVAC system 106 using the model, then the result of decision block 520 is NO, and the method 500 proceeds to an end block where it terminates.

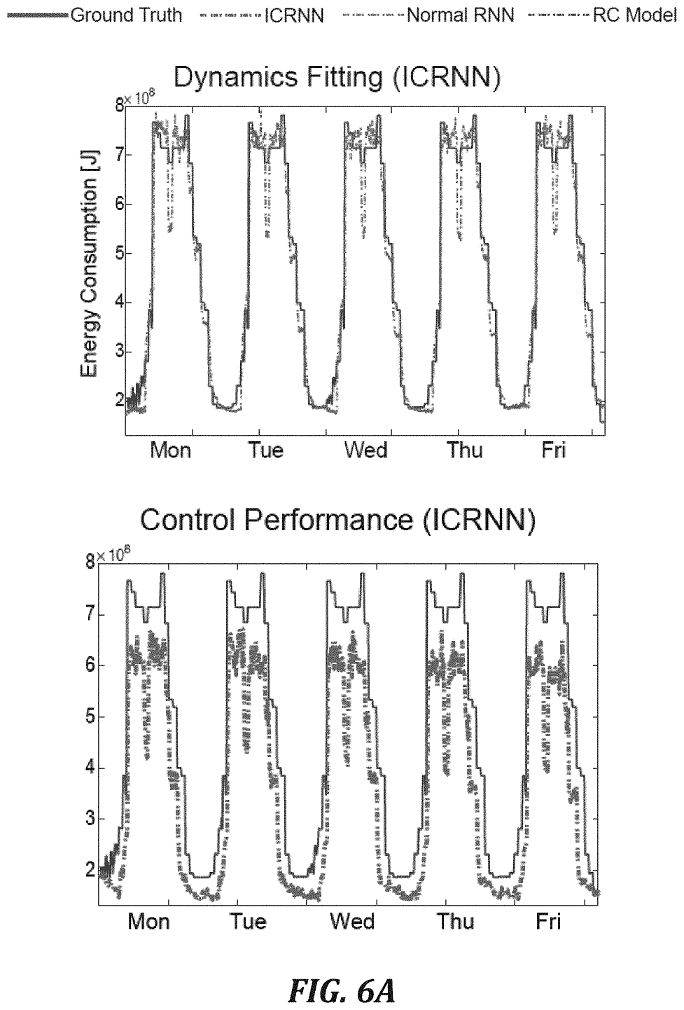

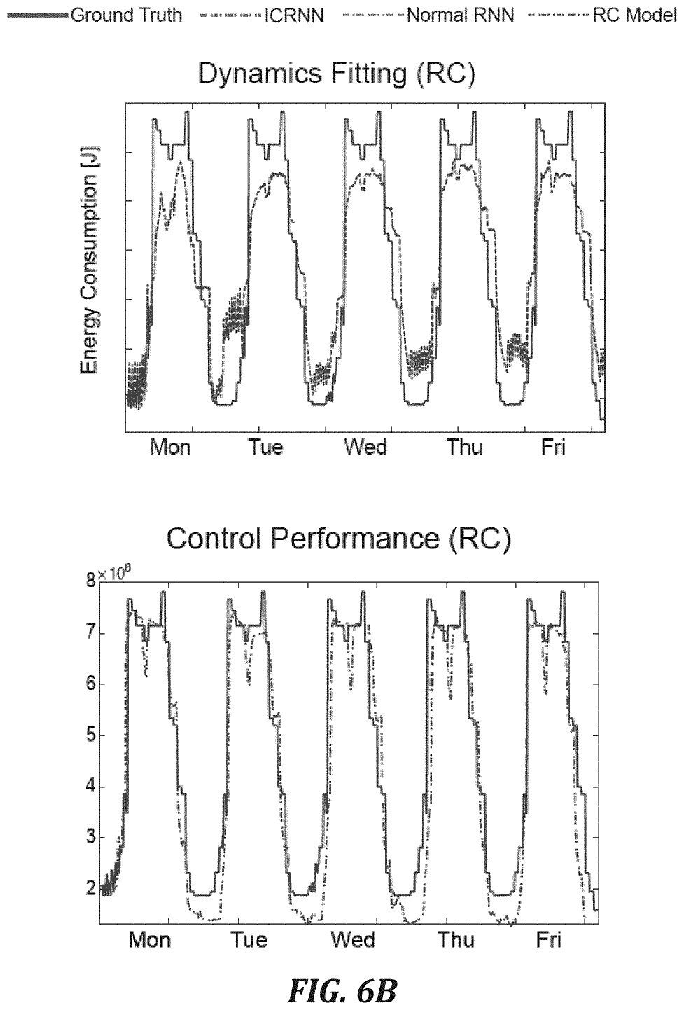

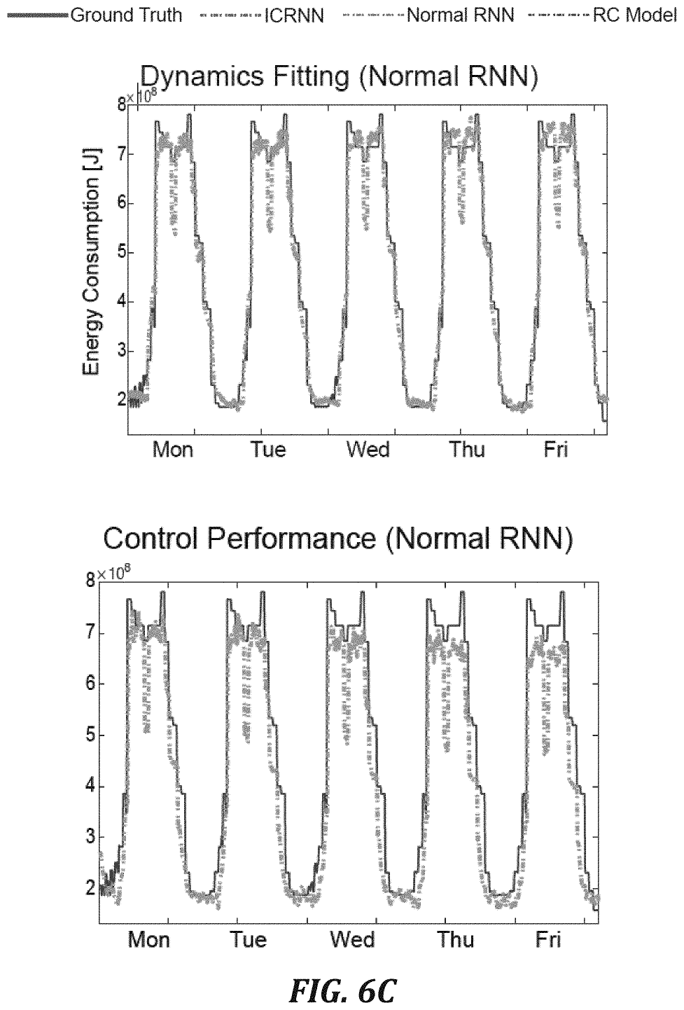

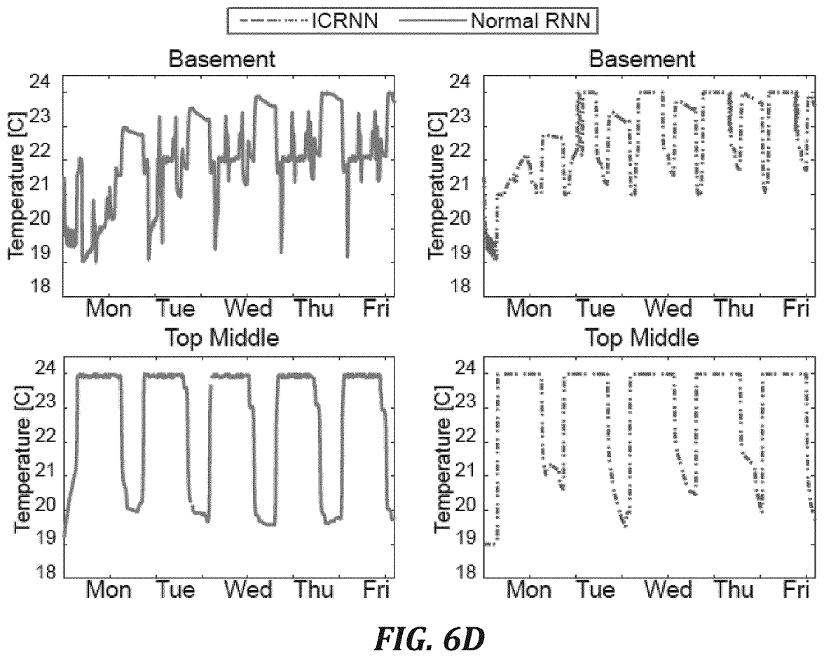

FIGS. 6A-6D illustrate various experimental results of using embodiments of the present disclosure to reduce energy consumption of an HVAC system 106. At time t, we assume the building's running profile xₜ:=[sₜ, uₜ] is available, where st denotes building system states, including outside temperature, room temperature measurements, zone occupancies, etc. uₜ denotes a collection of control actions such as room temperature set points and appliance schedule. Output is the electricity consumption Pₜ.

This is a model predictive control problem in the sense that we want to find the best control inputs that minimize the overall energy consumption of the building by looking ahead several time steps. To achieve this goal, an ICRNN model f(.) of the building dynamics is learned, which is trained to minimize the error between Pₜ and f (xₜ₋ₙ_{_{w}}, . . . , xₜ), while n_{w} denotes the memory window of recurrent neural networks. Then we solve:

minimizeᵤ_{ₜ}_{,u}_{ₜ₊₁}_{, . . . , u}_{_{t+T}}Σ_{τ=0}^{T}f(x_{t+τ-n}_{_{w}}, . . . , x_{t+τ}) (2a)

subject to s_{t+τ}=g(x_{t+τ-n}_{_{w}}, . . . , x_{t+τ-1},u_{t+τ),∉τ} (2b)

u_{t+τ}≤u_{t+τ},∉τ (2c)

s_{t+τ}≤s_{t+τ}≤s̅_{t+τ},∉τ (2d)

where the objective (2a) is minimizing the total energy consumption in future T steps (T is the model predictive control horizon), and (2b) is used for modeling building states, in which g(.) are parameterized as ICRNNs. This formulation is also flexible with different loss functions. For instance, in practice, a trained dynamics model (2b) could be reused, and electricity prices could be integrated into the overall objective so that real-time actions to minimize electricity usage and/or cost could be taken. The constraints on control actions uₜ and system states sₜ are given in (2c) and (2d). For instance, the temperature set points as well as real measurements should not exceed user-defined comfort regions.

To test the performance of the proposed method, we set up a 12-story large office building, which is a reference EnergyPlus commercial building model from US Department of Energy (DoE), with a total floor area of 498,584 square feet which is divided into 16 separate zones. By using the whole year's weather profile, we simulate the building running through the year and record (xₜ, Pₜ) with a resolution of 10 minutes. We use 10 months' data to train the ICRNN and subsequent 2 months' data for testing. We use 39 building system state variables sₜ (uncontrollable), along with 16 control variables uₜ. Output is a single value of building energy consumption at each time step. We set the model predictive control horizon T=36 (six hours). We employ an ICRNN with recurrent layer of dimension 200 to fit the building input-output dynamics f(.). The model is trained to minimize the MSE between its predictions and the actual building energy consumption using stochastic gradient descent. We use the same network structure and training scheme to fit state transition dynamics g(.).

We set the model-based forecasting and optimization benchmark using a linear resistor-circuit (RC) circuit model to represent the heat transfer in building systems, and solve for the optimal control actions via MPC. At each step, MPC algorithm takes into account the forecasted states of the building based on the fitted RC model and implements the current step control actions. We also compare the performance of ICRNN against the conventionally trained RNN in terms of building dynamics fitting performance and control performance. To solve the MPC problem with conventional RNN models, we also use gradient-based method with respect to controls. However, since conventional RNN models are generally not convex from input to output, there is no guarantee to reach a global optimum (or even a local one).

In terms of the fitting performance, ICRNN provides a competitive result compared to the conventional RNN model. The overall test root mean square error (RMSE) is 0.054 for ICRNN and 0.051 for conventional RNN, both of which are much smaller than the error made by the RC model (0.240). FIGS. 6A-6C show the fitting performance on 5 working days in test data, along with the control performance, for ICRNN, normal RNN, and an RC model as compared to a ground truth. This illustrates the good performance of ICRNN in modeling building HVAC system dynamics. Then, by using the learned ICRNN model of building dynamics, we obtain the suggested room control actions u*ₜ by solving the optimal building control problem in (2a)-(2d). As shown in FIGS. 6A-6C, with the same constraints on building temperature interval of 19 degrees Celsius to 24 degrees Celsius, the building energy consumption is reduced by 23.25% after implementing the new temperature set points calculated by ICRNN. On the contrary, since there is no guarantee for finding optimal control actions by optimizing over conventional RNN' s input, the control solutions given by conventional RNN could only reduce 11.73% of electricity. Solutions given by RC model only saves 4.07% of electricity. More importantly, in FIG. 6D, we demonstrate the control actions outputted by our method against MPC with conventional RNN in two randomly selected building zones, the building basement and top floor central area. It shows that our proposed approach is able to find a group of stable control actions for the building system control. Meanwhile, in the conventional RNN case, it generates control set points which have undesirable, drastic variations.

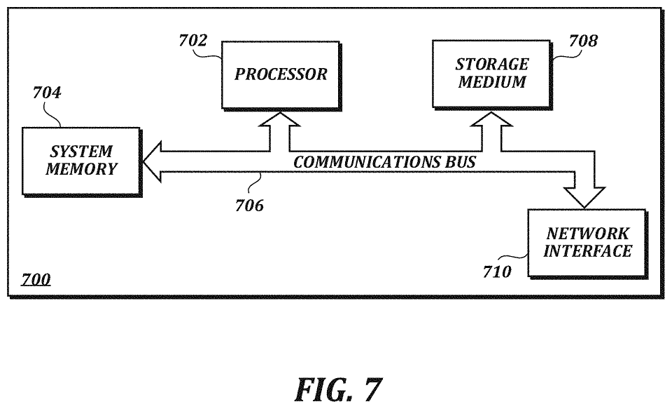

FIG. 7 is a block diagram that illustrates aspects of an exemplary computing device 700 appropriate for use as a computing device of the present disclosure. While multiple different types of computing devices were discussed above, the exemplary computing device 700 describes various elements that are common to many different types of computing devices. While FIG. 7 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 700 may be any one of any number of currently available or yet to be developed devices.

In its most basic configuration, the computing device 700 includes at least one processor 702 and a system memory 704 connected by a communication bus 706. Depending on the exact configuration and type of device, the system memory 704 may be volatile or nonvolatile memory, such as read only memory (“ROM”), random access memory (“RAM”), EEPROM, flash memory, or similar memory technology. Those of ordinary skill in the art and others will recognize that system memory 704 typically stores data and/or program modules that are immediately accessible to and/or currently being operated on by the processor 702. In this regard, the processor 702 may serve as a computational center of the computing device 700 by supporting the execution of instructions.

As further illustrated in FIG. 7, the computing device 700 may include a network interface 710 comprising one or more components for communicating with other devices over a network. Embodiments of the present disclosure may access basic services that utilize the network interface 710 to perform communications using common network protocols. The network interface 710 may also include a wireless network interface configured to communicate via one or more wireless communication protocols, such as WiFi, 2G, 3G, LTE, WiMAX, Bluetooth, Bluetooth low energy, and/or the like. As will be appreciated by one of ordinary skill in the art, the network interface 710 illustrated in FIG. 7 may represent one or more wireless interfaces or physical communication interfaces described and illustrated above with respect to particular components of the system 100.

In the exemplary embodiment depicted in FIG. 7, the computing device 700 also includes a storage medium 708. However, services may be accessed using a computing device that does not include means for persisting data to a local storage medium. Therefore, the storage medium 708 depicted in FIG. 7 is represented with a dashed line to indicate that the storage medium 708 is optional. In any event, the storage medium 708 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 704 and storage medium 708 depicted in FIG. 7 are merely examples of computer-readable media.

Suitable implementations of computing devices that include a processor 702, system memory 704, communication bus 706, storage medium 708, and network interface 710 are known and commercially available. For ease of illustration and because it is not important for an understanding of the claimed subject matter, FIG. 7 does not show some of the typical components of many computing devices. In this regard, the computing device 700 may include input devices, such as a keyboard, keypad, mouse, microphone, touch input device, touch screen, tablet, and/or the like. Such input devices may be coupled to the computing device 700 by wired or wireless connections including RF, infrared, serial, parallel, Bluetooth, Bluetooth low energy, USB, or other suitable connections protocols using wireless or physical connections. Similarly, the computing device 700 may also include output devices such as a display, speakers, printer, etc. Since these devices are well known in the art, they are not illustrated or described further herein.

While illustrative embodiments have been illustrated and described, it will be appreciated that various changes can be made therein without departing from the spirit and scope of the invention.

1. A system for controlling environmental conditions within a building, the system comprising:
a heating, ventilation, and air conditioning (HVAC) system;
one or more environmental sensors; and
an intelligent management device that includes:
at least one processor;
at least one network interface that communicatively couples the intelligent management device to the one or more environmental sensors and the HVAC system; and
a non-transitory computer-readable medium having computer-executable instructions stored thereon that, in response to execution by the at least one processor, cause the intelligent management device to perform actions comprising:
receiving, from the one or more environmental sensors, environmental data that represents an environment associated with the building;
using an input convex neural network model to determine one or more control inputs for the HVAC system based on the environmental data; and
transmitting the one or more control inputs to the HVAC system.

2. (canceled)

3. The system of claim 1, wherein the environmental sensors include at least one of a lighting level sensor, a wind sensor, an outdoor temperature sensor, a human occupancy sensor, a barometric pressure sensor, an energy consumption sensor, a building temperature sensor, a humidity sensor, and an energy price sensor.

4. The system of claim 1, wherein the input convex neural network model is an input convex recurrent neural network model.

5. The system of claim 1, wherein the input convex neural network model uses as inputs a set of values and a negation of the set of values.

6. The system of claim 5, wherein the inputs of the input convex recurrent neural network model are connected to a set of hidden layers by at least one direct passthrough layer, wherein the hidden layers of the set of hidden layers are connected using feedforward layers.

7. (canceled)

8. The system of claim 4, wherein the input convex recurrent neural network includes a set of hidden layers, wherein hidden layers of the set of hidden layers include one or more nodes, wherein the nodes of the hidden layers are connected via weighted connections, and wherein weights of the weighted connections are all non-negative.

9. The system of claim 1, wherein the input convex neural network model uses ReLU as an activation function.

10. A method of controlling environmental conditions within a building, the method comprising:
receiving, by a computing device, environmental data generated by one or more environmental sensors that represents an environment associated with the building;
providing, by the computing device, the environmental data as input to an input convex neural network model;
determining, by the computing device, one or more control inputs for a heating, ventilation, and air conditioning (HVAC) system based on one or more outputs of the input convex neural network model; and
transmitting the one or more control inputs to the HVAC system.

11. (canceled)

12. The method of claim 10, wherein providing the environmental data as input to an input convex neural network model includes providing the environmental data as input to an input convex recurrent neural network model.

13. The method of claim 10, wherein providing the environmental data as input to an input convex neural network model includes providing a set of values based on the environmental data and a negation of the set of values based on the environmental data.

14. The method of claim 13, wherein providing the environmental data as input to an input convex neural network model includes:
providing at least a set of values based on the environmental data to at least one direct passthrough layer; and
providing at least one result of the at least one direct passthrough layer to a set of hidden layers that are connected using feedforward layers.

15. (canceled)

16. The method of claim 14, wherein providing at least one result of the at least one direct passthrough layer to a set of hidden layers includes providing at least one result of the at least one direct passthrough layer to a set of hidden layers that are connected with weights that are all non-negative.

17. The method of claim 10, wherein the input convex neural network model uses ReLU as an activation function.

18. A non-transitory computer-readable medium having computer-executable instructions stored thereon that, in response to execution by one or more processors of a computing device, cause the computing device to perform actions for training a machine learning model to control environmental conditions within a building, the actions comprising:
determining, by the computing device, a set of fixed control inputs for a heating, ventilation, and air conditioning (HVAC) system;
transmitting, by the computing device, the set of fixed control inputs to the HVAC system;
receiving, by the computing device, environmental data generated by one or more environmental sensors that represents an environment associated with the building as affected by the HVAC system while operated using the set of fixed control inputs;
storing, by the computing device, the set of fixed control inputs and the environmental data in a training data store;
training, by the computing device, an input convex neural network model using information stored in the training data store; and
storing, by the computing device, the trained input convex neural network model in a model data store.

19. The computer-readable medium of claim 18, wherein training an input convex neural network model includes training an input convex recurrent neural network model.

20. The computer-readable medium of claim 18, wherein training an input convex neural network model includes:
determining a set of values based on the information stored in the training data store; and
using the set of values and a negation of the set of values as training data for training the input convex neural network model.

21. The computer readable medium of claim 18, wherein training an input convex neural network model includes training an input convex neural network model that has at least one direct passthrough layer between a set of inputs and a set of hidden layers.

22. The computer-readable medium of claim 18, wherein training an input convex neural network model includes training an input convex neural network model that has a set of hidden layers that are connected by feedforward layers.

23. The computer-readable medium of claim 18, wherein training an input convex neural network model includes training an input convex neural network model that includes a set of hidden layers, wherein hidden layers of the set of hidden layers include one or more nodes, wherein the nodes of the hidden layers are connected via weighted connections, and wherein weights of the weighted connections are all non-negative

24. The computer-readable medium of claim 18, wherein training an input convex neural network model includes training an input convex neural network model that uses ReLU as an activation function.

25-40. (canceled)
